(19) United States
(12) Patent Application Publication
(10) Pub. No.: US 2016/0362643 A1
(43) Pub. Date: Dec. 15, 2016

(54) Multipurpose Cleaner with No Volatile Organic Compounds

(71) Applicant: Andrew J. Kielbania, JR., Chalfont, PA (US)

(72) Inventor: Andrew J. Kielbania, JR., Chalfont, PA (US)

(21) Appl. No.: 15/174,439

(22) Filed: Jun. 6, 2016

Related U.S. Application Data
(60) Provisional application No. 62/171,456, filed on Jun. 5, 2015.

(51) Int. Cl. C11D 3/39; C11D 1/14; C11D 3/04; C11D 1/22; C11D 3/43

(52) U.S. Cl. CPC C11D 3/3902; C11D 1/22; C11D 3/43; C11D 3/044; C11D 3/3942; C11D 1/146

(57) ABSTRACT

The present invention provides for superior all purpose or multipurpose cleaners that are compliant with local and federal VOC (volatile organic compound) regulations, are not flammable, do not use ingredients which detract from the worlds food supply, are mild to surfaces and materials of construction with a near neutral pH, clean with less work and in a shorter period of time compared to currently commercial available cleaners.

### BACKGROUND

Recently, several events that have occurred have converged and have resulted in the need for new cleaners that have a high level of cleaning performance superior to currently available cleaners. The increased awareness of environmental protection has resulted in the general public's desire and at times demand to have cleaners that have ingredients which are based upon renewable resources such as ethanol derived from food sources such as corn, beets or soy. The environmental awareness initiative has also resulted in regulatory legislation that limits the VOC content, essentially across the board, in consumer and industrial products. A large portion of the general public has also developed a perception that if items are not clean or don't appear clean then they are dirty, unsafe and unhealthy. In order to overcome the above constraints and shortcomings of cleaners, manufacturers of cleaners have developed cleaners which are very caustic. A need exists with the general public for cleaners which are easy to use, require less work to clean and require less time to clean.

### PRIOR ART

U.S. Pat. No.
U.S. Pat. No. 8,961,680
U.S. Pat. No. 8,927,482
U.S. Pat. No. 8,835,370
U.S. Pat. No. 8,822,397
U.S. Pat. No. 8,821,648
U.S. Pat. No. 8,802,611
U.S. Pat. No. 8,785,366
U.S. Pat. No. 8,697,622
U.S. Pat. No. 8,617,317
U.S. Pat. No. 8,383,569
U.S. Pat. No. 8,222,194
U.S. Pat. No. 8,211,847
U.S. Pat. No. 7,786,068
U.S. Pat. No. 7,199,094
U.S. Pat. No. 6,815,405
U.S. Pat. No. 6,407,051
U.S. Pat. No. 6,191,087
U.S. Pat. No. 5,763,386
U.S. Pat. No. 5,573,702
U.S. Pat. No. 5,227,085
U.S. Pat. No. 4,565,647
U.S. Pat. No. 4,316,824

### SUMMARY OF THE INVENTION

The present invention provides for superior all purpose or multipurpose cleaners that are compliant with local and federal VOC (volatile organic compound) regulations, are not flammable, do not use ingredients which detract from the worlds food supply, are mild to surfaces and materials of construction with a near neutral pH, clean with less work and in a shorter period of time compared to currently commercial available cleaners.

### DETAILED DESCRIPTION OF THE INVENTION

The present invention provides cleaners with superior performance over currently available products while also complying with environmental concerns and legislated regulations. The present invention has overcome the inability to use in a water carrier with hydrogen peroxide the cleaning liquid components which are not VOC's resulting in a mild or near neutral pH cleaning formulation that is free of abrasives, alkyl phenol ethoxylate surfactants (APES), phosphates, ammonia, phosphorus compounds, chlorine, heavy metals, or phenolics. The present invention also provides a superior cleaner which does not require the use of excessive force to clean the soiled, stained or greasy surface.

Recently, several events that have occurred have converged and have resulted in the need for new cleaners that have a high level of cleaning performance superior to currently available cleaners. The increased awareness of environmental protection has resulted in the general public's desire and at times demand to have cleaners that have ingredients which are based upon renewable resources such as ethanol derived from food sources such as corn, beets or soy. However, these ethanol based cleaners do not perform well and in general have a poorer level of performance compared to traditional nonrenewable sources cleaners. In addition these new cleaners detract from the global food supply which will soon reach a critical stage. In addition as a result of containing ethanol, these cleaners have harmful VOC's (volatile organic compounds) which are detrimental to the environment. Also ethanol has a low flash point (below 65 degrees Fahrenheit) meaning that it is flammable and has associated safety issues.

The environmental awareness initiative has also resulted in regulatory legislation that limits the VOC content, essentially across the board, in consumer and industrial products. The limitation of VOC's is directed at preventing or reducing the formation of greenhouse gases and related global warming effect. The reduction in VOC's in products has also resulted in the diminishment of cleaner performance because substitutes for VOC's are usually poorly soluble or insoluble in water. Water is the preferred base or carriers for cleaners in general because of its environmental friendliness.

A large portion of the general public has also developed a perception that if items are not clean or don't appear clean then they are dirty, unsafe and unhealthy. Stains, soils and greases besides being unsightly can also harbor harmful microorganisms. Therefore, thorough cleaning or elimination of stains, soils and greases is a requirement of cleaner performance.

In order to overcome the above constraints and shortcomings of cleaners, manufacturers of cleaners have developed cleaners which are very caustic. They have incorporated very basic compounds such as amines, ammonia, caustic sodium or potassium hydroxide, or sodium silicates to enhance the cleaning power of their cleaners. However, these very caustic, high pH, greater than 11 or 12, have limited utility since they are harsh, corrosive or destroy many surfaces such as aluminum, zinc coated materials, galvanized surfaces and some plastics. These high pH cleaners have warnings on their label to such an effect. The high caustic pH of these cleaners limits their ease of use and utility since extra precautions must be used when handling these cleaners to protect the user's skin, eyes and clothing and surfaces being cleaned. Some manufacturers of cleaners have taken the opposite approach and developed cleaners which are very acidic, a pH of less than 3 and occasionally with a pH of 1 or less. Again these extreme pH cleaners have limited utility on acidic sensitive materials such as metals. The low acidic pH of these cleaners limits their ease of use and utility since extra precautions must be used when handling these cleaners to protect the user's skin, eyes and clothing and surfaces being cleaned.

A need exists with the general public for cleaners which are easy to use, require less work to clean and require less time to clean.

The ability of hydrogen peroxide to perform as an antimicrobial and it's environmentally friendliness are well recognized. In addition, using hydrogen peroxide in cleaners eliminates the need of using preservative such as methyl and chloro isothiazolinones which are hazardous and which are skin sensitizers. However, by itself hydrogen peroxide is a rather poor cleaner. In addition the stability of hydrogen peroxide is usually adversely affected in the presence of surfactants and other cleaning agents and additives.

The present invention provides for a superior water based, stable hydrogen peroxide containing multipurpose or all-purpose cleaner which uses environmentally friendly components, has a near neutral pH which allows it to be used on various surfaces, which is safe for use on colored surfaces or items, which has low or no VOC's, and free of abrasives, phosphates or phosphorous containing compounds, chlorine or other halogen containing compounds, heavy metals such as zinc, copper and other transition metals, harsh or sensitizing preservatives, and silicates or silicones. The cleaning formulation of the present invention has superior cleaning of soils, stains or grease and requires less work to clean surfaces compared to currently available commercial cleaners.

Embodiments of the present invention include a stable hydrogen peroxide water solution with pH modifiers, surfactants and organic cleaning agents which are water soluble and organic cleaning agents which have limited water solubility. For example, three organic cleaning agents are present in the cleaners of the present invention with at least one organic cleaning agent being water soluble, greater than 5 g solubility per 100 ml of water, and at least one organic cleaning agent having limited water solubility, less than 2 g solubility per 100 ml of water. A sufficient presence of water soluble organic cleaning agents insures the cleaning formulation of the present invention is homogeneous. At least about 20% of the organic cleaning agents in the present invention formulations are made up of water soluble organic cleaning agents. More preferably at least about 30% of the organic cleaning agents in the present invention formulations are made up of water soluble organic cleaners. Most preferably at least 40%% of the organic cleaning agents in the present invention formulations are made up of water soluble organic cleaners.

The flash points for the organic cleaning agents of the present invention are preferably above 200 degrees Fahrenheit and have a vapor pressure of less than 0.1 mm of mercury at 20 degrees Centigrade. The organic cleaning agents in the cleaners of the present invention may be lower alkyl, C1 to C6 alkyl, ethers of diethylene glycol or ester derivatives. More preferred are the C2 to C6 alkyl ethers of diethylene glycol or C2 to C6 ester derivatives. Most preferred are diethylene glycol ethyl ether (water solubility 100 g per 100 g of water), diethylene glycol butyl ether (water solubility 100 g per 100 g of water), diethylene glycol hexyl ether (water solubility 1.37 g per 100 g of water) and 2-(2-butoxyethoxy) ethyl acetate (water solubility 6.5 g per 100 g of water).

The work exerted to clean using the cleaners of the present invention can be less than 8 foot-pounds. Preferable the work exerted to clean using the cleaners of the present invention is less than 6 foot-pounds. Most preferably the work exerted to clean using the cleaners of the present invention is from 0.1 to 4 foot-pounds.

The total organic cleaning agents present in the cleaner formulation of the present invention is from 2% to 35%. More preferred from 3% to 25% and most preferred from 4% to 20%. The pH of the cleaners of the present invention is near neutral with a pH of from 4 to 10. The more preferred pH range is from 5 to 9.5 and the most preferred pH range is from 5.5 to 9. Having a cleaner with a near neutral pH provides for a cleaner with greater utility. Compared to cleaners of very high pH or very low pH which are detrimental to materials sensitive to acidic or caustic cleaners, a near neutral pH cleaner can be used to also flood or soak by immersion materials to be cleaned. The cleaners of very high pH, greater than 11, or very low pH, less than 4, would harm materials sensitive to pH and have less utility.

The amount of hydrogen peroxide content in the cleaners of the present invention is essentially 0.1% to 20%. More preferably the hydrogen peroxide content is 1% to 10% and most preferably the hydrogen peroxide content is from 2 to 8%.

The surfactants in the cleaners of the present invention are anionic or nonionic or combinations of both. Preferred anionic surfactants are sulfates, sulfonates or sulfosuccinates. The preferred nonionic surfactants are ethylene oxide and propylene oxide triblock polymers (commercially available as Pluronics® from BASF) and linear or branched alkyl ethoxylates. Description and characteristics of preferred surfactants are described in further detail in commonly owned U.S. Pat. No. 9,034,390, entitled “Anti-Microbial Composition and Method for Making and Using Same” which is incorporated by reference in its entirety. The most preferred surfactants are the alkali salts sodium lauryl sulfate and sodium dodecyl benzyl sulfonate.

Typical pH buffers and pH modifiers can be used in the present invention. Examples include but not limited to, are sodium or potassium hydroxide, citric acid, trisodium citrate, sulfuric acid, nitric acid. Others are well known in the art.

### Examples

The preparation of the cleaners was conducted at room temperature in a 250 ml beaker equipped with a magnetic stir bar. With stirring, the ingredients were charged into the beaker sequentially as listed with a five minute interval between ingredient additions. Upon completion of the addition of all the ingredients, agitation is continued and the pH is measured. The ingredients of the formulations of the present invention are available from Sigma Aldrich Company, Dow Chemical Company, BASF Corporation, Stepan Company, Walmart, and Target.

The work exerted to clean was measured as follows. SwiftLock Tuscany Stone Laminate Flooring D2788 purchased at Home Depot was marked with an approximately one inch long line of permanent marker. Parallel to this initial line another line was drawn using a different permanent marker. This procedure was repeated until all five different permanent markers were used. The parallel lines were spaced equally apart and the total distance from the first line to the last line was six inches. The permanent markers lines were allowed to dry 5 minutes. Then approximately 3 ml to 4 ml of cleaner was evenly applied and covered all 5 lines. The cleaner was allowed to have a 10 second contact time and then a flat microfiber towel (Microtex® Cleaning Microfiber Towel by Calderon Textiles available at Walmart) with a one quart bottle containing water to give a total weight of 2 pounds was pulled across the lines with a back and forth scrubbing motion until all 5 lines were eliminated or until a total of 60 back and forth scrubbing motions were completed. The portion of the microfiber towel with the quart bottle was drawn across the lines. After 10 back and forth scrubbing motions another 3 ml to 4 ml of cleaner was applied if all the lines have not been eliminated. This additional 3 ml to 4 ml of cleaner was applied after every set of 10 scrubbing motions. After 60 back and forth scrubbing motions if any of the permanent marker lines remained then the cleaner was considered as failing to clean or eliminate the permanent stains and the test stopped for that particular cleaner. The cylindrical one quart high density polyethylene carafe bottle had a circular base with a diameter of approximately 3.25 inches. The bottle with water weighed 2 pounds. The force used to pull the microfiber towel with bottle on top was measured with a scale, Berkley Portable Digital Scale BTDES 50-1 by Jarden Corporation purchased at Walmart. The scale was pulled in the direction of the displacement. The work was calculated by W=Fs, where W is work in this case foot-pounds, F is the constant force to cause the displacement measured by the scale, and s is the displacement in feet.

In the test the following 5 permanent markers were used to stain the Swift Lock Plus 30 Tuscany Laminate Flooring floor tile: Sharpie Permanent Marker; INC Permanent Marker; TUL Permanent Marker; BIC Permanent Marker; Office Max Permanent Marker. These markers were purchased at Walmart, Target and Office Max.

The work to clean as described above was measured for eight of the leading and popular commercially available consumer cleaners. The current leading commercially available near neutral pH or slightly basic cleaners are rather poor cleaners and require considerable work in trying to clean as seen in table 1. The results of these measurements are shown in Table 1 below:

TABLE 1

| | | Work in | |
|---|---|---|---|
| | | Foot- | |
| Work to Clean for Various Cleaners | pH | Pounds | Comments |
| Fantastic ® Scrubbing Bubbles ® All Purpose Cleaner - | 11.5 | 35.6 | Stains remain |
| SC Johnson | | | |
| Lysol ® All Purpose Cleaner Complete - Reckitt | 9.5 | 37.5 | Stains remain |
| Benckiser | | | |
| Formula 409 ® Cleaner Degreaser Disinfectant - Clorox | 11.0 | 30.0 | Stains remain |
| Formula 409 ® All Purpose Cleaner - Clorox | 11.0 | 33.7 | Stains remain |
| Lysol ® Power and Free Multipurpose Cleaner - Reckitt | 3.0 | 30.0 | Stains remain |
| Benckiser | | | |
| Clean Up ® Bleach - Clorox | 13.0 | 31.5 | All stains |
| | | | removed |
| Clorox Anywhere Hard Surface ™ Cleaner - Clorox | 4.5 | 46.9 | Stains remain |
| Windex ® Natures Source ® 99% Natural - SC Johnson | 9.0 | 41.3 | Stains remain |
| Example # 14 of the present invention | 7.0 | 0.6 | All stains |
| | | | removed |
| Example # 17 of the present invention | 8.5 | 0.7 | All stains |
| | | | removed |
| Example # 18 of the present invention | 8.5 | 0.7 | All stains |
| | | | removed |

The results from Table 1 clearly indicate that the cleaners of the present invention are superior to leading popular commercially available consumer cleaners.

The work to clean as described above was measured for seven of the leading and popular industrial, commercial cleaners. High pH cleaners may be more effective at cleaning than the near neutral pH or slightly basic cleaners but still inferior to the cleaners of the present invention. The high caustic pH of these cleaners limits their ease of use and utility since extra precautions must be used when handling these cleaners to protect the user's skin, eyes and clothing and surfaces being cleaned. Results are shown in Table 2:

TABLE 2

| | | Work in Foot- | |
|---|---|---|---|
| Work to Clean for Various Cleaners | pH | Pounds | Comments |
| Zep Commercial ® Fast 505 ® Industrial Cleaner & | 13.5 | 8.0 | All stains |
| Degreaser - Zep | | | removed |
| Simple Green ® Industrial Cleaner & Degreaser - | 9.5 | 9.4 | All stains |
| Sunshine Makers | | | removed |
| Spitfire ® RTU Cleaner - SC Johnson | 12.0 | 1.5 | All stains |
| | | | removed |
| Tough Duty ® NB - Spartan Chemical | 11.5 | 24.4 | Stains remain |
| Betco ® Speedex RTU Degreaser - Betco | 13.5 | 2.0 | All stains |
| | | | removed |
| Speedball ® Power Cleaner - SC Johnson | 12.5 | 1.3 | All stains |
| | | | removed |
| Simple Green ® Crystal Industrial Cleaner & | 9.5 | 9.5 | All Stains |
| Degreaser - Sunshine Makers | | | removed |
| Example # 14 of the present invention | 7.0 | 0.6 | All stains |
| | | | removed |
| Example # 17 of the present invention | 8.5 | 0.7 | All stains |
| | | | removed |
| Example # 18 of the present invention | 8.5 | 0.7 | All stains |
| | | | removed |

From the results in Tables 1 and 2 there is a strong correlation on a cleaner's ability to clean with the pH of the cleaner, the more basic or higher pH of the cleaner, the better the cleaner performance. This in contrast to the present invention where the near neutral pH cleaners of the present invention have superior cleaning performance over the prior art.

The following examples demonstrate the preparation of cleaners of the present invention. Included with each example is the pH and the work exerted to clean as described above. In the example below, #26, the Pluronic® F-108 surfactant is an ethylene oxide-propylene oxide-ethylene oxide triblock copolymer with an average molecular weight of 14,000, having a polyethylene oxide content of 80% and the molecular weight of the polypropylene oxide block of 3250. Formulation Examples—examples 1-34 of the present invention—are stable, homogeneous formulations and perform well as cleaners. Upon standing no oxygen bubbles were observed in these examples indicating the hydrogen peroxide was stable in the formulations of the present invention.

1.

| | | |
|---|---|---|
| 3% hydrogen peroxide - | 85.0 | g |
| Dodecylbenzene sulfonic acid - | 0.3 | g |
| Diethylene glycol butyl ether - | 5.0 | g |
| 2-(2 butoxyethoxy) ethyl acetate - | 5.0 | g |
| Diethylene glycol hexyl ether - | 5.0 | g |
| Sodium hydroxide - | 0.1 | g |
| Work = 1.3 foot-pounds; pH 7.0 | | |

2.

| | | |
|---|---|---|
| 3% hydrogen peroxide - | 85.0 | g |
| Dodecylbenzene sulfonic acid - | 0.3 | g |
| Diethylene glycol butyl ether - | 6.0 | g |
| 2-(2 butoxyethoxy) ethyl acetate - | 6.0 | g |
| Diethylene glycol hexyl ether - | 3.0 | g |
| Sodium hydroxide - | 0.1 | g |
| Work = 3.1 foot-pounds; pH 7.0 | | |

3.

| | | |
|---|---|---|
| 3% hydrogen peroxide - | 85.0 | g |
| Dodecylbenzene sulfonic acid - | 0.3 | g |
| Diethylene glycol butyl ether - | 7.0 | g |
| 2-(2 butoxyethoxy) ethyl acetate - | 5.0 | g |
| Diethylene glycol hexyl ether - | 3.0 | g |
| Sodium hydroxide - | 0.1 | g |
| Work = 3.9 foot-pounds; pH 7.0 | | |

4.

| | | |
|---|---|---|
| 3% hydrogen peroxide - | 85.0 | g |
| Dodecylbenzene sulfonic acid - | 0.3 | g |
| Diethylene glycol butyl ether - | 6.0 | g |
| 2-(2 butoxyethoxy) ethyl acetate - | 5.0 | |
| Diethylene glycol hexyl ether - | 4.0 | g |
| Sodium hydroxide - | 0.1 | g |
| Work = 5.3 foot-pounds; pH 7.0 | | |

5.

| | | |
|---|---|---|
| 3% hydrogen peroxide - | 85.0 | g |
| Dodecylbenzene sulfonic acid - | 0.3 | g |
| Diethylene glycol butyl ether - | 4.0 | g |
| 2-(2 butoxyethoxy) ethyl acetate - | 5.0 | |
| Diethylene glycol hexyl ether - | 5.0 | g |
| Sodium hydroxide - | 0.1 | g |
| Work = 3.4 foot-pounds; pH 7.0 | | |

6.

| | | |
|---|---|---|
| 3% hydrogen peroxide - | 85.0 | g |
| Dodecylbenzene sulfonic acid - | 0.3 | g |
| Diethylene glycol butyl ether - | 3.0 | g |
| 2-(2 butoxyethoxy) ethyl acetate - | 5.0 | |
| Diethylene glycol hexyl ether - | 5.0 | g |
| Sodium hydroxide - | 0.1 | g |
| Work = 2.0 foot-pounds; pH 7.0 | | |

7.

| | | |
|---|---|---|
| 3% hydrogen peroxide - | 85.0 | g |
| Dodecylbenzene sulfonic acid - | 0.3 | g |
| Diethylene glycol butyl ether - | 2.0 | g |
| 2-(2 butoxyethoxy) ethyl acetate - | 5.0 | |
| Diethylene glycol hexyl ether - | 5.0 | g |
| Sodium hydroxide - | 0.1 | g |
| Work = 1.9 foot-pounds; pH 7.0 | | |

8.

| | | |
|---|---|---|
| 3% hydrogen peroxide - | 85.0 | g |
| Dodecylbenzene sulfonic acid - | 0.3 | g |
| Diethylene glycol butyl ether - | 1.0 | g |
| 2-(2 butoxyethoxy) ethyl acetate - | 5.0 | |
| Diethylene glycol hexyl ether - | 5.0 | g |
| Sodium hydroxide - | 0.1 | g |
| Work = 1.1 foot-pounds; pH 7.0 | | |

9.

| | | |
|---|---|---|
| 3% hydrogen peroxide - | 85.0 | g |
| Dodecylbenzene sulfonic acid - | 0.3 | g |
| Diethylene glycol butyl ether - | 5.0 | g |
| 2-(2 butoxyethoxy) ethyl acetate - | 4.0 | |
| Diethylene glycol hexyl ether - | 5.0 | g |
| Sodium hydroxide - | 0.1 | g |
| Work = 2.4 foot-pounds; pH 7.0 | | |

10.

| | | |
|---|---|---|
| 3% hydrogen peroxide - | 85.0 | g |
| Dodecylbenzene sulfonic acid - | 0.3 | g |
| Diethylene glycol butyl ether - | 4.0 | g |
| 2-(2 butoxyethoxy) ethyl acetate - | 4.0 | |
| Diethylene glycol hexyl ether - | 5.0 | g |
| Sodium hydroxide - | 0.1 | g |
| Work = 2.8 foot-pounds; pH 7.0 | | |

11.

| | | |
|---|---|---|
| 3% hydrogen peroxide - | 85.0 | g |
| Dodecylbenzene sulfonic acid - | 0.3 | g |
| Diethylene glycol butyl ether - | 3.0 | g |
| 2-(2 butoxyethoxy) ethyl acetate - | 4.0 | |
| Diethylene glycol hexyl ether - | 5.0 | g |
| Sodium hydroxide - | 0.1 | g |
| Work = 1.8 foot-pounds; pH 7.0 | | |

12.

| | | |
|---|---|---|
| 3% hydrogen peroxide - | 85.0 | g |
| Dodecylbenzene sulfonic acid - | 0.3 | g |
| Diethylene glycol butyl ether - | 2.0 | g |
| 2-(2 butoxyethoxy) ethyl acetate - | 4.0 | |
| Diethylene glycol hexyl ether - | 5.0 | g |
| Sodium hydroxide - | 0.1 | g |
| Work = 2.3 foot-pounds; pH 7.0 | | |

13.

| | | |
|---|---|---|
| 3% hydrogen peroxide - | 85.0 | g |
| Dodecylbenzene sulfonic acid - | 0.3 | g |
| Diethylene glycol butyl ether - | 1.0 | g |
| 2-(2 butoxyethoxy) ethyl acetate - | 4.0 | |
| Diethylene glycol hexyl ether - | 5.0 | g |
| Sodium hydroxide - | 0.1 | g |
| Work = 1.1 foot-pounds; pH 7.0 | | |

14.

| | | |
|---|---|---|
| 3% hydrogen peroxide - | 85.0 | g |
| Dodecylbenzene sulfonic acid - | 0.3 | g |
| Diethylene glycol butyl ether - | 4.0 | g |
| 2-(2 butoxyethoxy) ethyl acetate - | 4.0 | g |
| Diethylene glycol hexyl ether - | 4.0 | g |
| Sodium hydroxide - | 0.1 | g |
| Work = 0.6 foot-pounds; pH 7.0 | | |

15.

| | | |
|---|---|---|
| 3% hydrogen peroxide - | 85.0 | g |
| Dodecylbenzene sulfonic acid - | 0.3 | g |
| Diethylene glycol butyl ether - | 3.5 | g |
| 2-(2 butoxyethoxy) ethyl acetate - | 3.5 | g |
| Diethylene glycol hexyl ether - | 3.5 | g |
| Sodium hydroxide - | 0.1 | g |
| Work = 1.3 foot-pounds; pH 7.0 | | |

16.

| | | |
|---|---|---|
| 3% hydrogen peroxide - | 85.0 | g |
| Dodecylbenzene sulfonic acid - | 0.3 | g |
| Diethylene glycol butyl ether - | 3.0 | g |
| 2-(2 butoxyethoxy) ethyl acetate - | 3.0 | g |
| Diethylene glycol hexyl ether - | 3.0 | g |
| Sodium hydroxide - | 0.1 | g |
| Work = 1.5 foot-pounds; pH 7.0 | | |

17.

| | | |
|---|---|---|
| 3% hydrogen peroxide - | 85.0 | g |
| Dodecylbenzene sulfonic acid - | 0.3 | g |
| Diethylene glycol butyl ether - | 4.0 | g |
| 2-(2 butoxyethoxy) ethyl acetate - | 4.0 | g |
| Diethylene glycol hexyl ether - | 4.0 | g |
| Triosodium citrate - | 0.1 | g |
| Sodium hydroxide - | 0.1 | g |
| Work = 0.7 foot-pounds; pH 8.5 | | |

18.

| | | |
|---|---|---|
| 3% hydrogen peroxide - | 85.0 | g |
| Dodecylbenzene sulfonic acid - | 0.3 | g |
| Diethylene glycol butyl ether - | 3.5 | g |
| 2-(2 butoxyethoxy) ethyl acetate - | 3.5 | g |
| Diethylene glycol hexyl ether - | 3.5 | g |
| Trisodium citrate - | 0.1 | g |
| Sodium hydroxide - | 0.1 | g |
| Work = 0.7 foot-pounds; pH 8.5 | | |

19.

| | | |
|---|---|---|
| 3% hydrogen peroxide - | 85.0 | g |
| Dodecylbenzene sulfonic acid - | 0.3 | g |
| Diethylene glycol butyl ether - | 3.0 | g |
| 2-(2 butoxyethoxy) ethyl acetate - | 3.0 | g |
| Diethylene glycol hexyl ether - | 3.0 | g |
| Trisodium citrate - | 0.1 | g |
| Sodium hydroxide - | 0.1 | g |
| Work = 1.6 foot-pounds; pH 8.0 | | |

20.

| | | |
|---|---|---|
| 3% hydrogen peroxide - | 85.0 | g |
| Dodecylbenzene sulfonic acid - | 0.3 | g |
| Diethylene glycol butyl ether - | 6.0 | g |
| 2-(2 butoxyethoxy) ethyl acetate - | 6.0 | g |
| Diethylene glycol hexyl ether - | 6.0 | g |
| Sodium hydroxide - | 0.1 | g |
| Work = 0.4 foot-pounds; pH 8.5 | | |

21.

| | | |
|---|---|---|
| 3% hydrogen peroxide - | 85.0 | g |
| Dodecylbenzene sulfonic acid - | 0.3 | g |
| Diethylene glycol butyl ether - | 8.0 | g |
| 2-(2 butoxyethoxy) ethyl acetate - | 8.0 | g |
| Diethylene glycol hexyl ether - | 8.0 | g |
| Sodium hydroxide - | 0.1 | g |
| Work = 1.5 foot-pounds; pH 8.0 | | |

22.

| | | |
|---|---|---|
| 3% hydrogen peroxide - | 85.0 | g |
| Dodecylbenzene sulfonic acid - | 0.3 | g |
| Diethylene glycol butyl ether - | 10.0 | g |
| 2-(2 butoxyethoxy) ethyl acetate - | 10.0 | g |
| Diethylene glycol hexyl ether - | 10.0 | g |
| Sodium hydroxide - | 0.1 | g |
| Work = 0.4 foot-pounds; pH 7.5 | | |

23.

| | | |
|---|---|---|
| 3% hydrogen peroxide - | 85.0 | g |
| Dodecylbenzene sulfonic acid - | 0.3 | g |
| Diethylene glycol butyl ether - | 2.0 | g |
| 2-(2 butoxyethoxy) ethyl acetate - | 2.0 | g |
| Diethylene glycol hexyl ether - | 2.0 | g |
| Sodium hydroxide - | 0.1 | g |
| Work = 2.8 foot-pounds; pH 8.5 | | |

24.

| | | |
|---|---|---|
| 3% hydrogen peroxide - | 85.0 | g |
| Dodecylbenzene sulfonic acid - | 0.3 | g |
| Diethylene glycol butyl ether - | 1.5 | g |
| 2-(2 butoxyethoxy) ethyl acetate - | 1.5 | g |
| Diethylene glycol hexyl ether - | 1.5 | g |
| Sodium hydroxide - | 0.1 | g |
| Work = 3.4 foot-pounds; pH 8.5 | | |

25.

| | | |
|---|---|---|
| 3% hydrogen peroxide - | 85.0 | g |
| Dodecylbenzene sulfonic acid - | 0.3 | g |
| Diethylene glycol butyl ether - | 1.0 | g |
| 2-(2 butoxyethoxy) ethyl acetate - | 1.0 | g |
| Diethylene glycol hexyl ether - | 1.0 | g |
| Sodium hydroxide - | 0.1 | g |
| Work = 5.6 foot-pounds; pH 9.0 | | |

26.

| | | |
|---|---|---|
| 3% hydrogen peroxide - | 85.0 | g |
| PLURONIC F-108 | 1.3 | g |
| Diethylene glycol butyl ether - | 4.0 | g |
| 2-(2 butoxyethoxy) ethyl acetate - | 4.0 | g |
| Diethylene glycol hexyl ether - | 7.0 | g |
| Sodium hydroxide - | 0.1 | g |
| Work = 0.9 foot-pounds; pH 9.0 | | |

27.

| | | |
|---|---|---|
| 3% hydrogen peroxide - | 85.0 | g |
| Dodecylbenzene sulfonic acid - | 0.3 | g |
| Diethylene glycol butyl ether - | 4.0 | g |
| 2-(2 butoxyethoxy) ethyl acetate - | 4.0 | g |
| Diethylene glycol hexyl ether - | 4.0 | g |
| Citric acid | 0.1 | g |
| Sodium hydroxide - | 0.1 | g |
| Work = 0.4 foot-pounds; pH 5.5 | | |

28.

| | | |
|---|---|---|
| 3% hydrogen peroxide - | 85.0 | g |
| Dodecylbenzene sulfonic acid - | 0.3 | g |
| Diethylene glycol butyl ether - | 3.5 | g |
| 2-(2 butoxyethoxy) ethyl acetate - | 3.5 | g |
| Diethylene glycol hexyl ether - | 3.5 | g |
| Citric acid | 0.1 | g |
| Sodium hydroxide - | 0.1 | g |
| Work = 0.5 foot-pounds; pH 5.5 | | |

29.

| | | |
|---|---|---|
| 3% hydrogen peroxide - | 85.0 | g |
| Dodecylbenzene sulfonic acid - | 0.3 | g |
| Diethylene glycol butyl ether - | 3.0 | g |
| 2-(2 butoxyethoxy) ethyl acetate - | 3.0 | g |
| Diethylene glycol hexyl ether - | 3.0 | g |
| Citric acid | 0.1 | g |
| Sodium hydroxide - | 0.1 | g |
| Work = 0.9 foot-pounds; pH 6.5 | | |

30.

| | | |
|---|---|---|
| 3% hydrogen peroxide - | 85.0 | g |
| Dodecylbenzene sulfonic acid - | 0.3 | g |
| Diethylene glycol butyl ether - | 4.0 | g |
| 2-(2 butoxyethoxy) ethyl acetate - | 4.0 | g |
| Diethylene glycol hexyl ether - | 4.0 | g |
| Citric acid | 0.1 | g |
| Triosodium citrate - | 0.1 | g |
| Sodium hydroxide - | 0.1 | g |
| Work = 1.0 foot-pounds; pH 6.5 | | |

31.

| | | |
|---|---|---|
| 3% hydrogen peroxide - | 85.0 | g |
| Dodecylbenzene sulfonic acid - | 0.3 | g |
| Diethylene glycol butyl ether - | 3.5 | g |
| 2-(2 butoxyethoxy) ethyl acetate - | 3.5 | g |
| Diethylene glycol hexyl ether - | 3.5 | g |
| Citric acid | 0.1 | g |
| Trisodium citrate - | 0.1 | g |
| Sodium hydroxide - | 0.1 | g |
| Work = 0.9 foot-pounds; pH = 6.0 | | |

32.

| | | |
|---|---|---|
| 3% hydrogen peroxide - | 85.0 | g |
| Dodecylbenzene sulfonic acid - | 0.3 | g |
| Diethylene glycol butyl ether - | 3.0 | g |
| 2-(2 butoxyethoxy) ethyl acetate - | 3.0 | g |
| Diethylene glycol hexyl ether - | 3.0 | g |
| Trisodium citrate - | 0.1 | g |
| Citric acid | 0.1 | g |
| Sodium hydroxide - | 0.1 | g |
| Work = 1.4 foot-pounds; pH = 7.0 | | |

33.

| | | |
|---|---|---|
| 3% hydrogen peroxide - | 85.0 | g |
| Dodecylbenzene sulfonic acid - | 0.3 | g |
| Sodium lauryl sulfate 30% - | 0.3 | g |
| Pluronic F-108 - | 0.3 | g |
| Diethylene glycol butyl ether - | 3.0 | g |
| 2-(2 butoxyethoxy) ethyl acetate - | 3.0 | g |
| Diethylene glycol hexyl ether - | 3.0 | g |
| Trisodium citrate - | 0.1 | g |
| Citric acid | 0.1 | g |
| Sodium hydroxide - | 0.1 | g |
| Work = 1.2 foot-pounds; pH = 7.0 | | |

34.

| | | |
|---|---|---|
| 3% hydrogen peroxide - | 85.0 | g |
| Sodium lauryl sulfate 30% - | 1.3 | g |
| Diethylene glycol butyl ether - | 3.0 | g |
| 2-(2 butoxyethoxy) ethyl acetate - | 3.0 | g |
| Diethylene glycol hexyl ether - | 3.0 | g |
| Trisodium citrate - | 0.1 | g |
| Work = 3.5 foot-pounds; pH = 7.5 | | |

The following examples demonstrate the need for a sufficient amount of water soluble organic cleaner agents in the presence of a water insoluble organic cleaner agents in order to produce a stable one phase, homogeneous cleaner of the present invention. Cleaners which are not homogeneous and form two phases have limited utility.

35.

| | |
|---|---|
| 3% hydrogen peroxide - | 85.0 g |
| Dodecyl benzene sulfonic acid - | 0.3 g |
| Diethylene glycol butyl ether - | 3.0 g |
| 2-(2 butoxyethoxy) ethyl acetate - | 2.5 g |
| Diethylene glycol hexyl ether - | 10.0 g |
| Sodium hydroxide - | 0.1 g |

A stable homogeneous formulation is formed in this example.

36.

| | |
|---|---|
| 3% hydrogen peroxide - | 85.0 g |
| Dodecyl benzene sulfonic acid - | 0.3 g |
| Diethylene glycol butyl ether - | 2.5 g |
| 2-(2 butoxyethoxy) ethyl acetate - | 2.5 g |
| Diethylene glycol hexyl ether - | 10.0 g |
| Sodium hydroxide - | 0.1 g |

A stable homogeneous formulation is formed in this example.

37.

| | |
|---|---|
| 3% hydrogen peroxide - | 85.0 g |
| Dodecylbenzene sulfonic acid - | 0.3 g |
| Diethylene glycol butyl ether - | 2.5 g |
| 2-(2 butoxyethoxy) ethyl acetate - | 2.0 g |
| Diethylene glycol hexyl ether - | 10.0 g |
| Sodium hydroxide - | 0.1 g |

A stable homogeneous formulation is formed in this example.

38.

| | |
|---|---|
| 3% hydrogen peroxide - | 85.0 g |
| Dodecylbenzene sulfonic acid - | 0.3 g |
| Diethylene glycol butyl ether - | 2.0 g |
| 2-(2 butoxyethoxy) ethyl acetate - | 2.0 g |
| Diethylene glycol hexyl ether - | 10.0 g |
| Sodium hydroxide - | 0.1 g |

An unstable two phase formulation is formed in this example.

39.

| | |
|---|---|
| 3% hydrogen peroxide - | 85.0 g |
| Dodecylbenzene sulfonic acid - | 0.3 g |
| Diethylene glycol butyl ether - | 2.0 g |
| 2-(2 butoxyethoxy) ethyl acetate - | 1.5 g |
| Diethylene glycol hexyl ether - | 10.0 g |
| Sodium hydroxide - | 0.1 g |

An unstable two phase formulation is formed in this example.

40.

| | |
|---|---|
| 3% hydrogen peroxide - | 85.0 g |
| Dodecylbenzene sulfonic acid - | 0.3 g |
| Diethylene glycol butyl ether - | 1.5 g |
| 2-(2 butoxyethoxy) ethyl acetate - | 1.5 g |
| Diethylene glycol hexyl ether - | 10.0 g |
| Sodium hydroxide - | 0.1 g |

An unstable two phase formulation is formed in this example.

What is claimed is:

1. A multipurpose cleaner free of chlorine, phosphorous, alkyl phenol ethoxylate based surfactants, ammonia, silicates, heavy metals, abrasives with little or no volatile organic compounds and is not flammable having a near neutral pH and requiring less than 8 foot pounds of work to clean, the multipurpose cleaner consisting of: a hydrogen peroxide water solution, surfactant, and at least one of water soluble organic cleaning agents and organic cleaning agents with limited water solubility, pH adjusters and pH buffers.
